(19) United States
(12) Patent Application Publication
(10) Pub. No.: US 2023/0005659 A1
(43) Pub. Date: Jan. 5, 2023

(54) SYSTEMS AND METHODS FOR IMPROVING WINDING LOSSES IN PLANAR TRANSFORMERS

(71) Applicant: Navitas Semiconductor Limited, Dublin (IE)

(72) Inventors: Xiucheng Huang, Torrance, CA (US); Bin Li, Pleasanton, CA (US); Weijing Du, Torrance, CA (US); Yun Zhou, Shenzhen (CN)

(73) Assignee: Navitas Semiconductor Limited, Dublin (IE)

(21) Appl. No.: 17/853,767

(22) Filed: Jun. 29, 2022

Related U.S. Application Data
(60) Provisional application No. 63/240,631, filed on Sep. 3, 2021.

(30) Foreign Application Priority Data
Jul. 5, 2021 (CN) 202110756638.8

(51) Int. Cl. H01F 27/34; H01F 27/24

(52) U.S. Cl. CPC H01F 27/34; H01F 27/24

(57) ABSTRACT

Systems and methods for improving winding losses in transformers. In one aspect, a transformer includes a first magnetic core having a first portion in contact with a second magnetic core and a second portion separated from the second magnetic core by a distance d, a plurality of primary windings formed around the second portion, a first secondary winding forming a first layer having a first inner diameter, a second secondary winding forming an n^{th} layer having a second inner diameter. The plurality of primary windings are positioned between the first layer and the n^{th} layer, where the plurality of primary windings, and the first secondary winding and the second secondary winding are formed around the second portion, and a difference between the first inner diameter and the second inner diameter defines a distance y, and a ratio of distance y to distance d is between 0.01 to 10.

### CROSS REFERENCE TO RELATED APPLICATIONS

This application claims priority to China provisional patent application Ser. No. 202110756638.8, for “A Method To Reduce Winding Loss Of Planar Transformer” filed on Jul. 5, 2021, and U.S. provisional patent application Ser. No. 63/240,631, for “Systems and Methods for Improving Winding Losses in Planar Transformers” filed on Sep. 3, 2021, the contents of which are incorporated herein by reference in their entirety for all purposes.

### FIELD

The described embodiments relate generally to transformers for power converters, and more particularly, the present embodiments relate to systems and methods for improving winding losses in transformers that are used in power converters.

### BACKGROUND

Electronic devices such as computers, servers and televisions, among others, employ one or more electrical power conversion circuits to convert one form of electrical energy to another. Some electrical power conversion circuits convert a high DC voltage to a lower DC voltage using a circuit topology called a half bridge converter. As many electronic devices are sensitive to size and efficiency of the power conversion circuit, new power converters can provide relatively higher efficiency and lower size for the new electronic devices.

### SUMMARY

In some embodiments, a transformer is disclosed. The transformer includes a first magnetic core having a first portion in contact with a second magnetic core and a second portion separated from the second magnetic core by a distance d, a plurality of primary windings formed around the second portion, a first secondary winding forming a first layer having a first inner diameter, a second secondary winding forming an n^{th} layer having a second inner diameter, where the plurality of primary windings are positioned between the first layer and the n^{th} layer, and where the plurality of primary windings, and the first secondary winding and the second secondary winding are formed around the second portion, and where a difference between the first inner diameter and the second inner diameter defines a distance y, and a ratio of distance y to distance d is between 0.01 to 10.

In some embodiments, the second magnetic core defines a recess adjacent the second portion and having a depth x.

In some embodiments, the first magnetic core is an E-core.

In some embodiments, the second magnetic core is an I-core.

In some embodiments, a value of the ratio of distance y to distance d is 2.

In some embodiments, a transformer is disclosed. The transformer include a first magnetic core having a first portion in contact with a second magnetic core and a second portion separated from the second magnetic core by a distance k, a plurality of primary windings formed around the second portion, a first secondary winding forming a first layer, a second secondary winding forming an n^{th} layer, where the plurality of primary windings are positioned between the first layer and the n^{th} layer, and where the plurality of primary windings, and the first secondary winding and the second secondary winding are formed around the second portion, where the second magnetic core defines a recess adjacent the n^{th} layer and having a depth t.

In some embodiments, the first magnetic core is an E-core.

In some embodiments, the second magnetic core is an I-core.

In some embodiments, a ratio of depth t to distance k is between 0.01 to 10.

In some embodiments, a ratio of depth t to distance k is 1.

In some embodiments, the first layer has a first inner diameter and the n^{th} layer has a second inner diameter, and where a difference between the first inner diameter and the second inner diameter defines a distance z, and a ratio of distance z to distance k is between 0.01 to 10.

In some embodiments, a transformer is disclosed. The transformer includes a first magnetic core having a first portion in contact with a second magnetic core and a second portion separated from the second magnetic core by a distance e, a plurality of primary windings formed around the second portion, a first secondary winding forming a first layer, a second secondary winding forming an n^{th} layer, where the plurality of primary windings are positioned between the first layer and the n^{th} layer, and where the plurality of primary windings, and the first secondary winding and the second secondary winding are formed around the second portion, where the second magnetic core defines a recess adjacent the second portion and having a depth w.

In some embodiments, the first magnetic core is an E-core.

In some embodiments, the second magnetic core is an I-core.

In some embodiments, a ratio of depth w to distance e is between 0.01 to 10.

In some embodiments, a ratio of depth w to distance e is between 1.0.

In some embodiments, the recess is formed in shape of a rectangle.

In some embodiments, the recess is formed in shape of a trapezoid.

In some embodiments, the recess is formed in shape of an arc-trapezoid.

In some embodiments, the first layer has a first inner diameter and the n^{th} layer has a second inner diameter, and where a difference between the first inner diameter and the second inner diameter defines a distance q, and a ratio of distance q to distance e is between 0.01 to 10.

### BRIEF DESCRIPTION OF THE DRAWINGS

FIG. 1 illustrates a planar transformer with a keep-away distance between windings and an air gap according to an embodiment of the disclosure;

FIG. 2 illustrates a graph showing winding losses as a function of a ratio of the keep-away distance to the air gap length for the planar transformer of FIG. 1;

FIG. 3 illustrates a transformer with a recessed regions in a second magnetic core structure, according to an embodiment of the disclosure;

FIG. 4A illustrates distribution of the air gap fringing magnetic flux without a recessed region in the second magnetic core structure. FIG. 4B illustrates distribution of the air gap fringing magnetic flux with a recessed region in the second magnetic core structure. FIG. 4C illustrates a graph showing winding losses as a function of depth of the recessed regions in the second magnetic core in the planar transformer of FIG. 3;

FIG. 5 illustrates a planar transformer with a sunken middle leg structure having a rectangular recessed section according to an embodiment of the disclosure;

FIG. 6 illustrates a planar transformer with a sunken middle leg structure having a trapezoidal recessed section is according to embodiments of the invention;

FIG. 7 illustrates a planar transformer with a sunken middle leg structure having an arc-trapezoidal recessed section according to an embodiment of the disclosure;

FIG. 8 illustrates winding losses as a function of an extension distance for rectangular, trapezoidal and arc-trapezoidal recessed sections for FIGS. 5, 6 and 7;

FIG. 9 illustrates a structure and an optimization method for trapezoidal shaped recessed section of the planar transformer of FIG. 6 according to an embodiment of the invention; and

FIG. 10 illustrates winding losses as a function of an angle in the trapezoidal recessed section of FIG. 9.

### DETAILED DESCRIPTION

Devices, structures and related techniques disclosed herein relate generally to power conversion devices. More specifically, devices, structures and related techniques disclosed herein relate to systems and methods for improving winding losses in planar transformers used in power conversion circuits. In some embodiments, a planar transformer may include a first magnetic core that is in contact with a second magnetic core, where a first section of the first magnetic core forms an air gap with the second magnetic core. The planar transformer can further include a first primary formed around the first section. The planer transformer may further include a first secondary winding formed on a first layer, and a second secondary winding forming an n^{th} layer, where the first secondary winding and the second secondary winding are formed around the first section. The primary windings may be positioned between the first layer and the n^{th} layer. The n^{th} layer may be pulled back from the air gap by a keep-away distance. By increasing a distance between the n^{th} layer and the air gap, the winding losses in the transformer can be reduced thereby increasing an efficiency of the power conversion circuit. In various embodiments, a method of optimizing a ratio of the keep-away distance to a thickness of the air gap is disclosed. By optimizing this ratio, embodiments of the disclosure can enable a reduction of winding losses in the transformer, thereby improving an overall efficiency of the power conversion circuit.

In various embodiments, the planar transformer can include an E-core and an I-core. In some embodiments, the planar transformer can include an I-core with a recess adjacent the first section of the E-core. The recess may be formed in various shapes, for example, but not limited to, a rectangle, a trapezoid, or an arc-trapezoid. The formation of a recess enables a reduction winding losses and improve overall efficiency of the power conversion circuit. In various embodiments, a method of optimizing a ratio of depth of the recess to the air gap thickness of is disclosed.

In some embodiments, material from some regions of the I-core that are adjacent to the n^{th} layer can be removed, forming recessed regions in the I-core. This can result in a reduction of winding losses in the planar transformer. In various embodiments, a method of optimizing a ratio of depth of the recess to the air gap thickness of is disclosed. Various inventive embodiments are described herein, including methods, processes, systems, devices, and the like.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

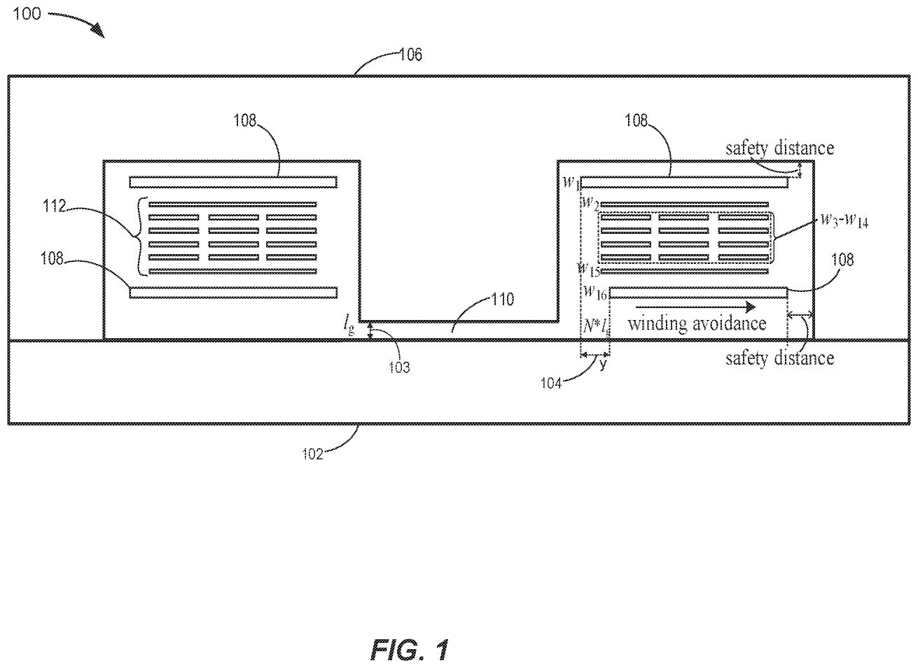

FIG. 1 illustrates a planar transformer 100 according to an embodiment of the disclosure. As shown in FIG. 1, planar transformer 100 can include a first magnetic core 106, a second magnetic core 102, primary winding 112 and secondary windings 108, and an air gap 110. In the illustrated embodiment, the planar transformer 100 can include an EI-core and an 8-layer printed circuit board (PCB) winding, however other embodiments can have other suitable configurations, e.g., number of layer can vary according to specific application. The air gap 110 can be formed between the middle leg of an E-core and a center portion of an I-core. A length of the air gap is denoted by 103 (lg). The length lg of the air gap can be, for example, 0.24 mm. However, other suitable air gap lengths can be used. The primary windings 112 can include, for example, 14 turns, which is illustrated as w₂ to w₁₅, however other embodiments can have other suitable number of turns. The secondary windings 108 can include, for example, 2 turns, which is described as w₁ and w₁₆, however other embodiments can have other suitable number of turns. In the illustrated embodiment, winding w₁₆ can be pulled away from the air gap 110 to create a keep-away distance 104 (y). An effect of air gap fringing flux on the winding w₁₆ can be minimized by increasing a distance between w₁₆ and the air gap 110, thus reducing winding losses. In the illustrated embodiment, a ratio (N) of the keep-away distance 104 to the air gap length 103 (lg) can be given by:

N=y/lg

In some embodiments, the ratio N can be set approximately equal to or close to an integer. By keeping the ratio N approximately equal or close to an integer, an optimum keep-away distance between the windings and the air gap can be determined. In various embodiments, systems and methods for improving winding losses in planar transformers can determine an optimal ratio of the keep-away distance to the air gap length for any transformer core shapes such as, but not limited to, EIR, EI, U, or C-shaped cores, and to any number of winding layers in the planar transformer.

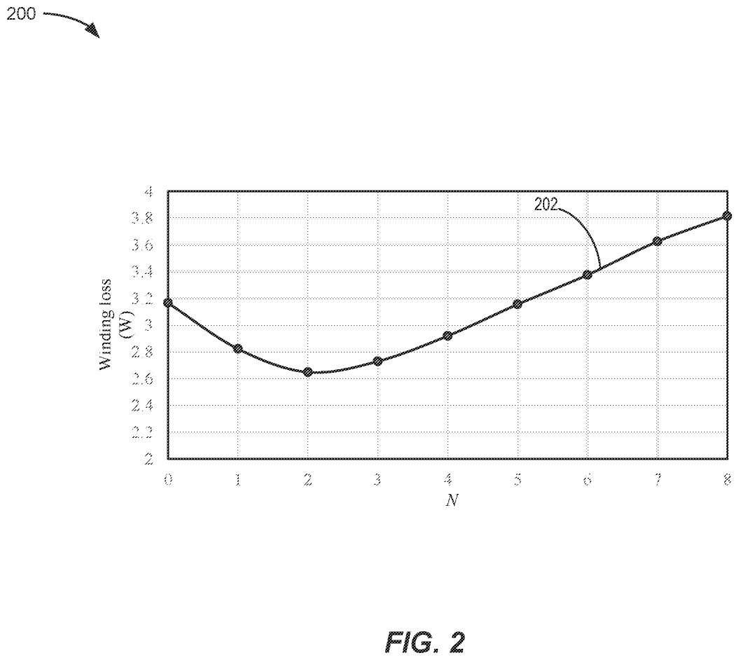

FIG. 2 illustrates a graph 200 showing winding losses as a function of ratio N, where N is increased from 0 to 8, according to embodiments of the disclosure. As can be seen in graph 202, there is an optimal value where the winding losses are at a minimum. For example, in graph 202, a ratio value of 2 (i.e. when the keep away distance is twice the length of the air gap) produces an optimal reduction of winding losses. As appreciated by one of ordinary skill in the art having the benefit of this disclosure, a value for ratio N be set to any suitable value for a specific application to minimize transformer winding losses. In some embodiments, a value of ratio N that can minimize transformer winding losses may vary from 0.01 to 10, while in other embodiments a value of ratio N that can minimize transformer winding losses may vary from 0.05 to 8, while in yet other embodiments a value of ratio N that can minimize transformer winding losses may vary from 1 to 3.

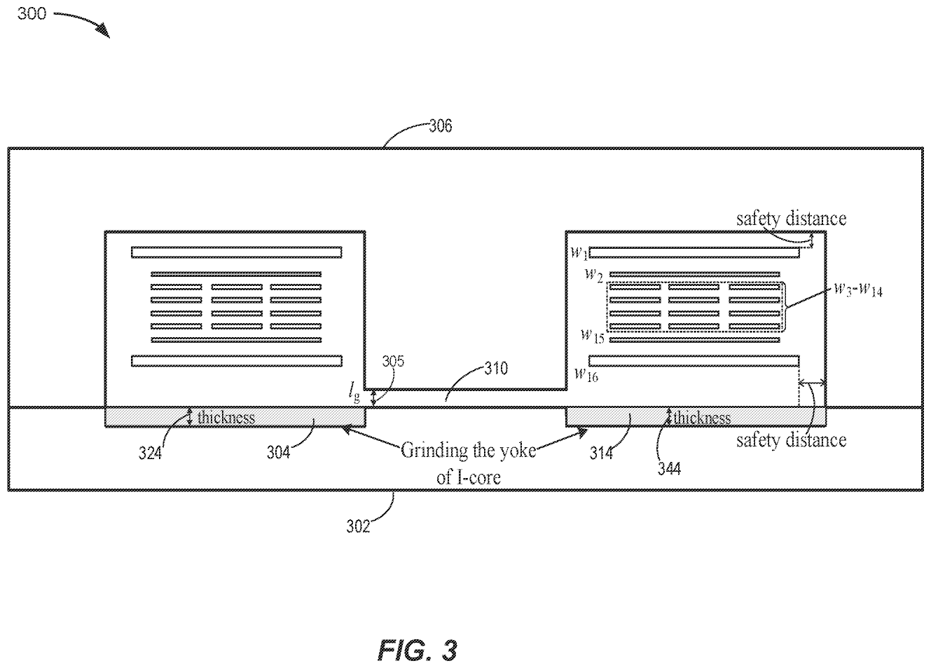

Now referring to FIG. 3, a planar transformer 300 is shown where some portions of a second magnetic core are removed according to an embodiment of the disclosure. Planar transformer 300 can include an E-core 306, an I-core 302 and an air gap 310. Magnetic core material from sections 304 and 314 of the I-core 302 can be removed, thereby forming recessed regions. Removal of material in sections 304 and 314 can be achieved, for example, by grinding, ablation, cutting or raw forming. The air gap 310 can have a thickness 305 (lg). Section 304 can have a depth 324, and section 314 can have a depth 344.

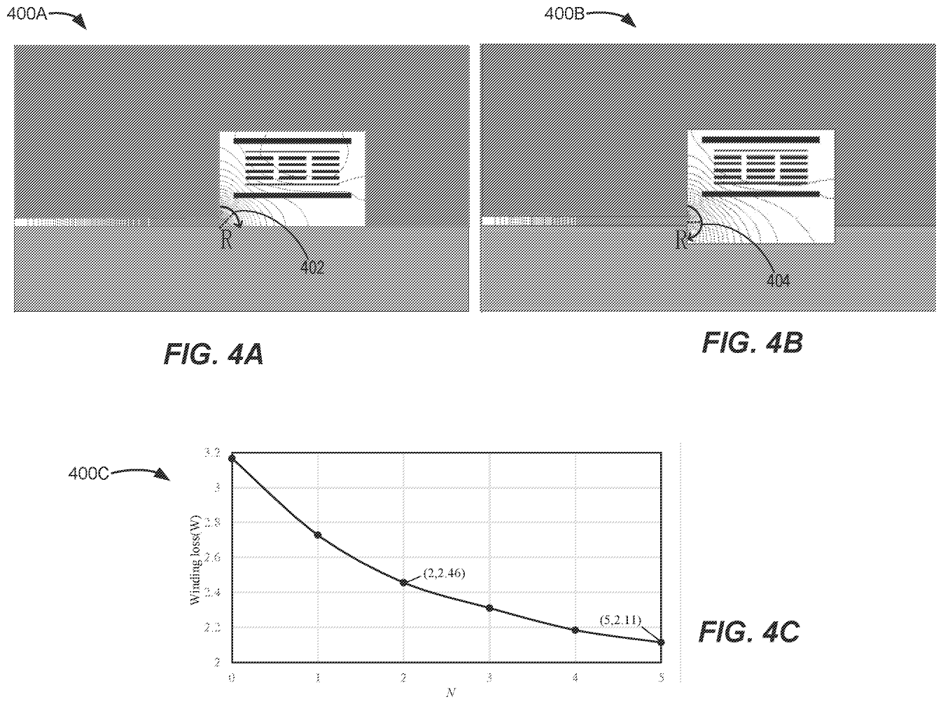

Now referring to FIG. 4A, simulation results 400A show distribution of air gap fringing magnetic flux in the planar transformer 300 without a removed yoke section, according to embodiments of the disclosure. Simulation results 400A show air gap fringing magnetic flux 402 for a structure without removal of sections 304 or 314. FIG. 4B illustrates simulation results 400B showing distribution of air gap fringing magnetic flux in the planar transformer 300 with a removed yoke section, according to embodiments of the disclosure. Simulation results 400B show air gap fringing magnetic flux 404 with sections 304 and 314 removed. In 400A, the air gap fringing flux 402 has a relatively short magnetic path, which is equal to 0.5πR. A magnetic field intensity H₁ can be described by an expression:

$${H}_{1} = \frac{{U}_{m g}}{0.5 π \cdot R}$$

where U_{mg} is the magnetic potential difference of the air gap, and R is the magnetic path's equivalent radius of the air gap fringing flux. Removal of magnetic core material from the of I-core in sections 304 and 314 can increase a length of the magnetic path of the air gap fringing magnetic flux, where a length of a path of the air gap fringing magnetic flux 404 can increase to πR from 0.5πR. The new magnetic field intensity H₂ can be described by expression:

$${H}_{1} = \frac{{U}_{m g}}{π \cdot R}$$

Thus, with removal of sections 304 and 314, the EI-core structure can be modified into EE-core structure resulting in increased magnetic paths of air gap fringing fluxes, thereby reducing the magnetic field intensity in the magnetic core. In some embodiments, recessed regions 304 and 314 may cause the air gap magnetic field to move down, resulting in a further weakening of the influence of air gap fringing magnetic flux, thus resulting in reduced windings losses.

FIG. 4C illustrates a graph 400C showing winding losses as a function of air gap thickness 305 (lg) in planar transformer 300, according to embodiments of the disclosure. Graph 400C shows the transformer winding loss as a function of a ratio of a thickness of removed sections 304/314 to the air gap length. As illustrated in graph 400C, depth 324, which may be approximately equal to depth 344, can increases from 0 to five times a value of the air gap length (5lg). As can be seen in graph 400C, when a depth of the recessed regions is twice the length of the air gap (2lg), the winding loss is approximately equal to 2.46 W, and when the depth of the recessed regions is 5lg , the winding loss is reduced to approximately 2.11 W. As appreciated by one of skill in the art having the benefit of this disclosure, in some embodiments a ratio of depth 324 to I_{g} may vary from 0.01 to 10, while in other embodiments the ratio may vary from 0.05 to 8, while in yet other embodiments the ratio may vary from 1 to 3.

As can be seen in graph 400C, the winding loss of planar transformer 300 can be reduced by removing sections 304 and 314 from of the I-core 302. Therefore, the larger depth of removed sections 304 and 314 in the I-core 302 results in smaller transformer winding losses. In various embodiments, an optimal value for the depth of sections 304 and 314 can be, for example, equal to twice as large as the air gap length lg. In various embodiments, the disclosed structures and method to remove sections from the magnetic core be applied to any core shapes such as, but not limited to, EIR, EI, U, or C-shaped cores.

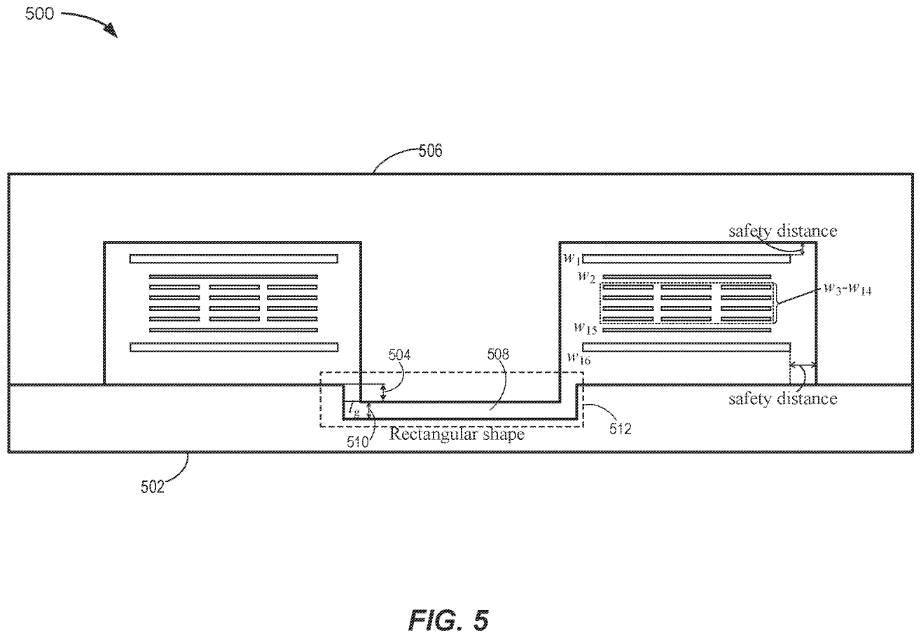

Now referring to FIG. 5, a planar transformer 500 with a recessed middle leg structure is illustrated according to an embodiment of the disclosure. Planar transformer 500 can include a magnetic E-core 506 and I-core 502. In the illustrated embodiment, a middle section of the magnetic E-core 506 can be extended into the I-core 502 in order to create a recessed section 512 in the I-core 502, where the air gap 508 can be moved inside the recessed section 512. In some embodiments, the air gap 508 can be partially inside the I-core 502. In various embodiments, the air gap 508 can be completely inside the I-core 502. In some embodiments, an optimum reduction in winding loss can be achieved by having a structure where extension distance 504 of the middle leg of the magnetic E-core 506 can be approximately equal to air gap length 510 (lg).

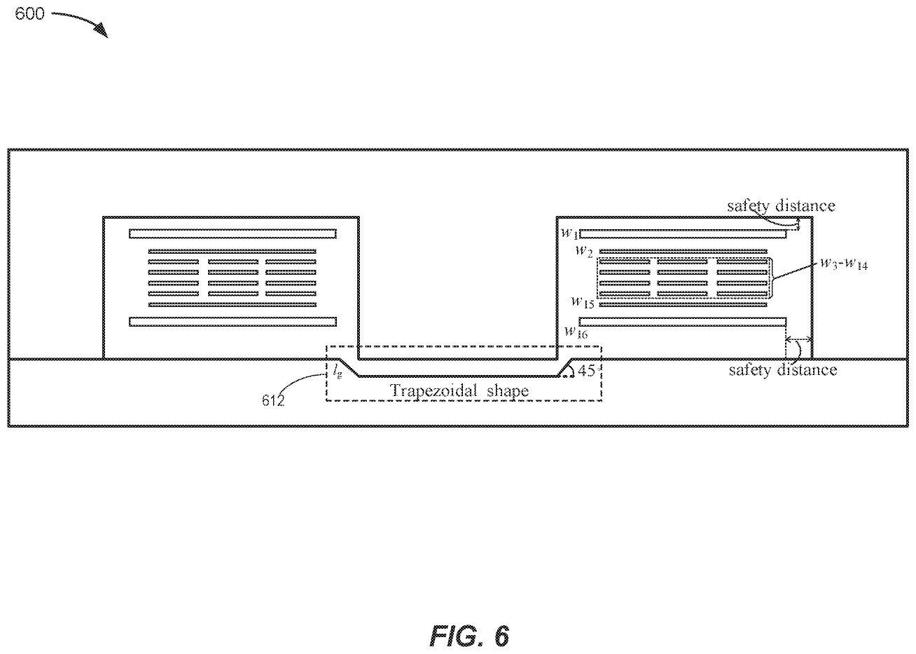

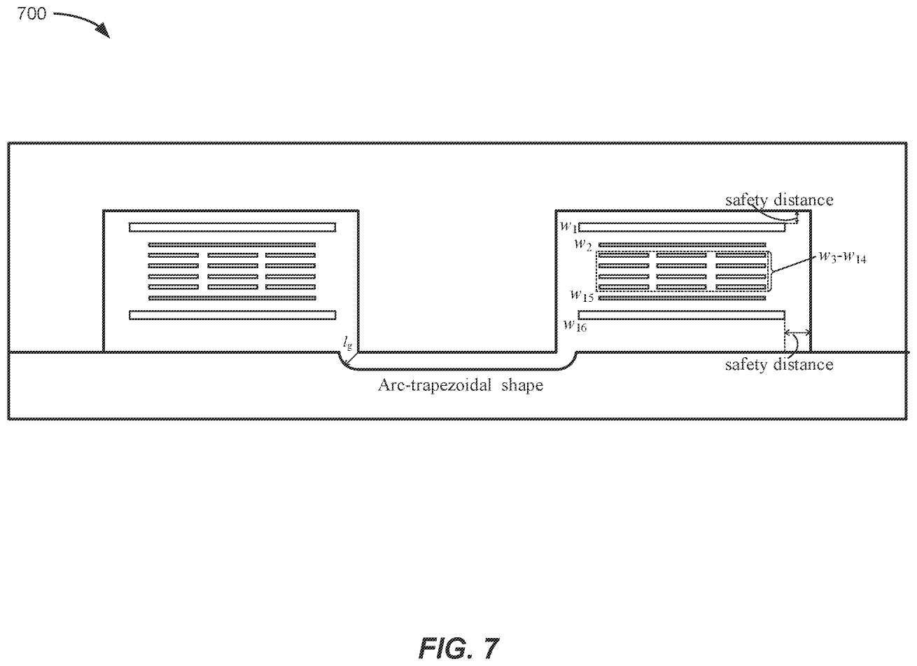

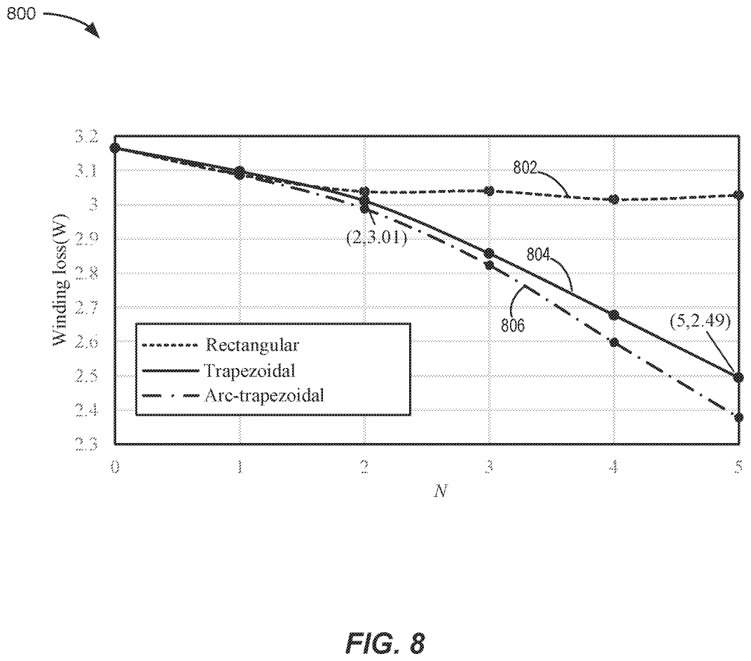

Various shapes of the recessed section 512 in the I-core can produce varying amounts of reduction in the winding loss of the planar transformer. Referring simultaneously to planar transformer 500 in FIG. 5, planar transformer 600 in FIG. 6, and planar transformer 700 in FIG. 7, rectangular, trapezoidal and arc-trapezoidal shapes of the recessed section 512 are illustrated according to embodiments of the invention. FIG. 8 illustrates a graph 800 showing transformer winding loss as a function of extension distance 504 for rectangular shape 802, trapezoidal shape 804 and arc-trapezoidal shape 806. The x-axis shows the extension distance 504 as a function of air gap length lg, going from 0 to 5lg. As can be seen in FIG. 8, trapezoidal shape 804 and arc-trapezoidal shape 806 produce relatively larger reduction in the transformer winding losses. As can be seen in graph 800, the winding losses of planar transformer can be reduced by sinking the middle leg of E-magnetic core into the I-magnetic core. Further, increases in the sinking height distance can result in relatively smaller winding losses.

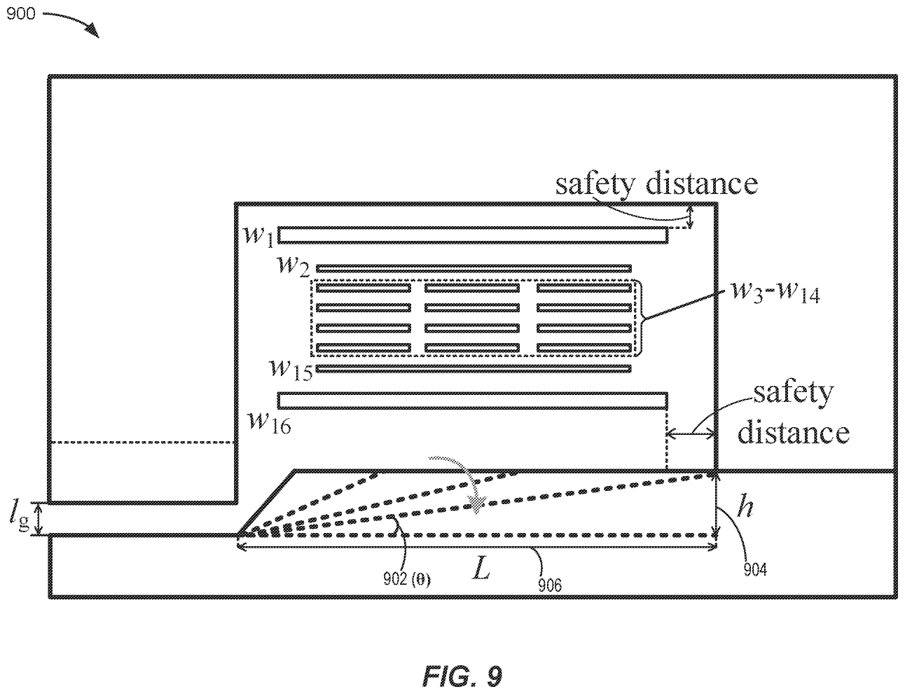

Referring now to FIG. 9, structures and methods for optimizing a shape of a trapezoidal structure of the recessed section 612 of the transformer of FIG. 6 is described according to an embodiment of the invention. In FIG. 9, section 900 of the planar transformer 600 is shown in detail. An angle 902 of trapezoidal section, called θ, can affect reduction in winding losses in the planar transformer 600. In the illustrated embodiment, as θ gets smaller, the winding losses are reduced. A minimum value of θ can be determined by the expression:

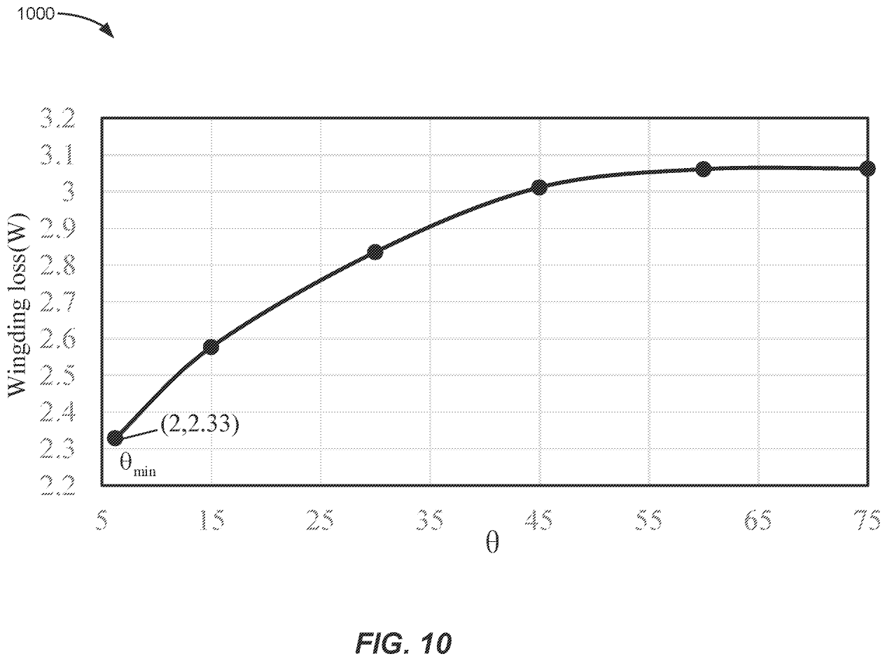

θₘᵢₙ=arctan(h/L)

where h (904) is the sinking height of middle leg and L (906) is the width of core window of planar transformer. FIG. 10 illustrates a graph 1000 showing transformer winding loss as a function of θ. As can be seen in graph 1000, smaller values of θ can result in smaller winding loss.

In some embodiments, a combination of the structures and/or techniques disclosed herein can be utilized in order to achieve greater reduction in planar transformer winding losses compared to a single structure or technique to reduce the winding losses. Although structures and methods are described and illustrated herein with respect to one particular configuration of a planar transformer, embodiments of the disclosure are suitable for use with other configurations of planar transformers, such as, but not limited to, U or C-shape transformers. Moreover, embodiments of the disclosure are suitable for use with other transformer configurations, such as, but not limited to, non-planar transformers.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A transformer comprising:
a first magnetic core having a first portion in contact with a second magnetic core and a second portion separated from the second magnetic core by a distance d;
a plurality of primary windings formed around the second portion;
a first secondary winding forming a first layer having a first inner diameter;
a second secondary winding forming an n^{th} layer having a second inner diameter, wherein the plurality of primary windings are positioned between the first layer and the n^{th} layer, and wherein the plurality of primary windings, and the first secondary winding and the second secondary winding are formed around the second portion; and
wherein a difference between the first inner diameter and the second inner diameter defines a distance y, and a ratio of distance y to distance d is between 0.01 to 10.

2. The transformer of claim 1, wherein the second magnetic core defines a recess adjacent the second portion and having a depth x.

3. The transformer of claim 1, wherein the first magnetic core is an E-core.

4. The transformer of claim 2, wherein the second magnetic core is an I-core.

5. The transformer of claim 1, wherein a value of the ratio of distance y to distance d is 2.

6. A transformer comprising:
a first magnetic core having a first portion in contact with a second magnetic core and a second portion separated from the second magnetic core by a distance k;
a plurality of primary windings formed around the second portion;
a first secondary winding forming a first layer;
a second secondary winding forming an n^{th} layer, wherein the plurality of primary windings are positioned between the first layer and the n^{th} layer, and wherein the plurality of primary windings, and the first secondary winding and the second secondary winding are formed around the second portion;
wherein the second magnetic core defines a recess adjacent the n^{th} layer and having a depth t.

7. The transformer of claim 6, wherein the first magnetic core is an E-core.

8. The transformer of claim 6, wherein the second magnetic core is an I-core.

9. The transformer of claim 6, wherein a ratio of depth t to distance k is between 0.01 to 10.

10. The transformer of claim 6, wherein a ratio of depth t to distance k is 1.

11. The transformer of claim 6, wherein the first layer has a first inner diameter and the n^{th} layer has a second inner diameter, and wherein a difference between the first inner diameter and the second inner diameter defines a distance z, and a ratio of distance z to distance k is between 0.01 to 10.

12. A transformer comprising:
a first magnetic core having a first portion in contact with a second magnetic core and a second portion separated from the second magnetic core by a distance e;
a plurality of primary windings formed around the second portion;
a first secondary winding forming a first layer;
a second secondary winding forming an n^{th} layer, wherein the plurality of primary windings are positioned between the first layer and the n^{th} layer, and wherein the plurality of primary windings, and the first secondary winding and the second secondary winding are formed around the second portion;
wherein the second magnetic core defines a recess adjacent the second portion and having a depth w.

13. The transformer of claim 11, wherein the first magnetic core is an E-core.

14. The transformer of claim 11, wherein the second magnetic core is an I-core.

15. The transformer of claim 11, wherein a ratio of depth w to distance e is between 0.01 to 10.

16. The transformer of claim 11, wherein a ratio of depth w to distance e is between 1.0.

17. The transformer of claim 11, wherein the recess is formed in shape of a rectangle.

18. The transformer of claim 11, wherein the recess is formed in shape of a trapezoid.

19. The transformer of claim 11, wherein the recess is formed in shape of an arc-trapezoid.

20. The transformer of claim 11, wherein the first layer has a first inner diameter and the n^{th} layer has a second inner diameter, and wherein a difference between the first inner diameter and the second inner diameter defines a distance q, and a ratio of distance q to distance e is between 0.01 to 10.
